(19) United States
(12) Patent Application Publication
(10) Pub. No.: US 2003/0233818 A1
(43) Pub. Date: Dec. 25, 2003

(54) Magnetic air filter

(76) Inventor: Ralph Hensley, Owingsville, KY (US)

Correspondence Address: Ralph Hensley, P. O. Box 330, Owingsville, KY, 40360, US

(21) Appl. No.: 10/175,789

(22) Filed: Jun. 20, 2002

(51) Int. Cl. B01D 46/00

(52) U.S. Cl. 55/490

(57) ABSTRACT

An air filter modified with magnetic material bonded To the back surface of the housing of an air filter, Therefore allowing the modified air filter to be attached to any suitable surface

### BACKGROUND OF THE INVENTION

This invention relates to a method to attach an air filter to an object. The traditional way adds cost in the manufacturing process of the object that requires an air filter. In some of the heating and cooling systems, to install an air filter is not very simple. The method that I have invented is a very simple way to install an air filter. The improvements I have made to an air filter could be very beneficial to many objects that uses air filters. The idea was conceived while observing my computer. The dust that is in a house or building could be drawn into a computer. To incorporate a method to hold a traditional air filter on a computer air intake would add cost to the computer.

### SUMMARY OF THE INVENTION

This invention would be a great benefit to computers. The components of a computer could be harmed by dust particles. The air filter that I have modified has magnetic material bonded to the back surface of the housing of an air filter, which would allow the modified air filter to be attached to the opening where the air is drawn into a computer. This could eliminate some repair bills on a computer. This invention is an improvement to an air filter. With magnetic material bonded to the housing of an air filter, more options would be available to mount an air filter to an object. The magnetic material will allow the air filter to be attached to any suitable surface.

### DESCRIPTION OF THE DRAWINGS

FIG. 1 is a view showing the front of an air filter with the air filter material enclosed in the housing.

FIG. 2 is a view showing the magnetic material bonded to the air filter housing with the air filter material enclosed within the housing.

FIG. 3 is a view showing the magnetic material with an opening for air to enter the air filter material.

FIG. 4 is an end view showing the magnetic material with an opening for air to enter the air filter material.

### PREFERRED EMBODIMENT

For the purposes of promoting an understanding of the principles of the invention, reference will now be made to the embodiment illustrated in the drawings.

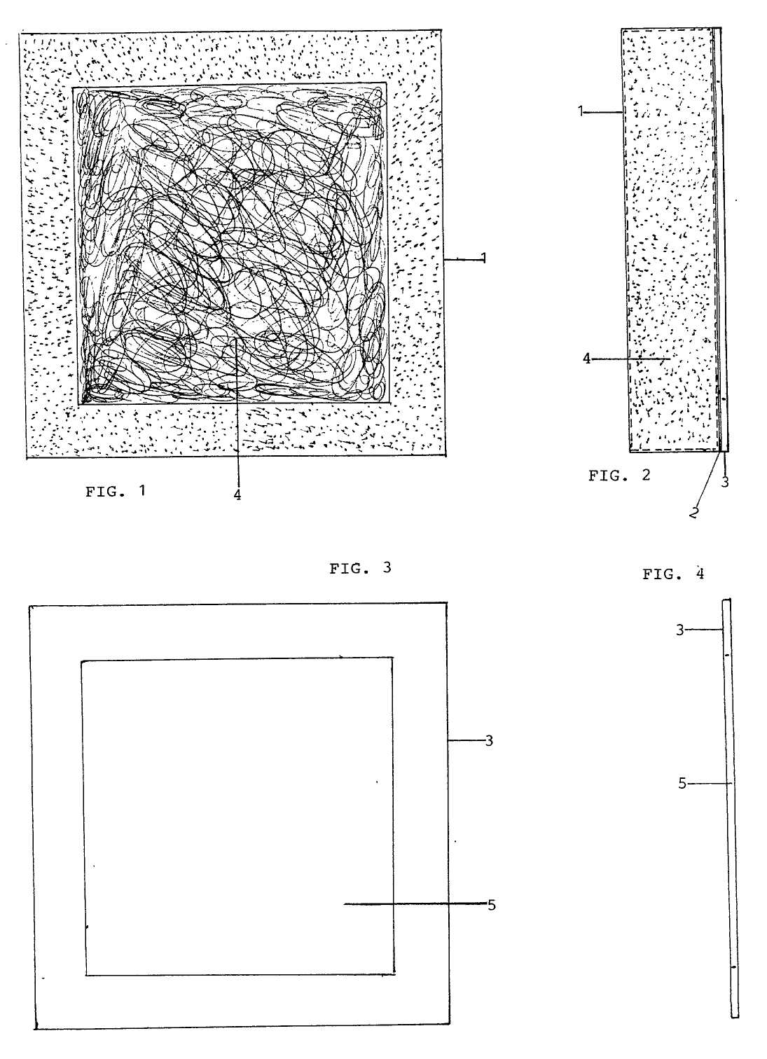

Referring to FIG. 1 there is illustrated an air filter housing 1 with the air filter material 4 enclosed within the housing 1.

FIG. 2 illustrates the magnetic material 3 bonded to the back surface 2 of the air filter housing 1 with the air filter material 4 enclosed within the air filter housing 1.

FIG. 3 illustrates the magnetic material 3 with an opening 5 for the air to enter the air filter material 4.

FIG. 4 is an end view off the magnetic material 3 with an opening 5 for air to enter the air filter material 4.

I claim:

1. A method for attaching an air filter to a suitable object.
Wherein said method consist of bonding magnetic Material to the back surface of the housing of an air filter.
Wherein said magnetic material has an opening for air To enter the said air filter material.
